(19) United States
(12) Patent Application Publication
(10) Pub. No.: US 2025/0198777 A1
(43) Pub. Date: Jun. 19, 2025

(54) PATH FINDING METHOD, PATH FINDING APPARATUS, AND TRANSPORT SYSTEM

(71) Applicant: SEMES CO,.LTD., Chungcheongnam-do (KR)

(72) Inventors: Sik KIM, Gyeonggi-do (KR); Byung Kwon LEE, Gyeonggi-do (KR); Geochul JEONG, Gyeonggi-do (KR)

(21) Appl. No.: 18/798,839

(22) Filed: Aug. 9, 2024

(30) Foreign Application Priority Data
Dec. 18, 2023 (KR) 10-2023-0184073

(51) Int. Cl. G01C 21/34

(52) U.S. Cl. CPC G01C 21/3469

(57) ABSTRACT

A path finding method capable of determining an optimal path for a transport vehicle equipped with a battery is provided. The path finding method includes: setting a destination for a transport vehicle using a battery; calculating costs between waypoints to the destination using a cost function, which includes amounts of charging and discharging occurring between the waypoints as an input variable; and determining a path to the destination based on the calculated costs.

### CROSS-REFERENCE TO RELATED APPLICATION

This application claims priority from Korean Patent Application No. 10-2023-0184073 filed on Dec. 18, 2023, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a path finding method, a path finding apparatus, and a transport system.

### 2. Description of the Related Art

In the manufacturing process of semiconductor devices, substrates can be transported through an automated transport system. Specifically, the automated transport system may include transport vehicles (such as overhead hoist transports (OHTs), rail guided vehicles (RGVs), etc.) that are designed to move along track rails installed on the ceiling or floor of a cleanroom. The operation of the transport vehicles can be controlled by a higher-level controller, such as an OHT control server (OCS) device.

The transport vehicles can move by receiving power through power lines installed in the track rails. The transport vehicles are equipped with batteries internally, allowing them to use the energy stored in the batteries to move when traveling on track rails where the power lines are not installed.

### SUMMARY

The present disclosure provides a path finding method that can determine an optimal path for a transport vehicle equipped with a battery.

The present disclosure also provides a path finding apparatus that can determine the optimal path for a transport vehicle equipped with a battery.

The present disclosure also provides a transport system that can determine the optimal path for a transport vehicle equipped with a battery.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, a path finding method includes: setting a destination for a transport vehicle using a battery; calculating costs between waypoints to the destination using a cost function, which includes amounts of charging and discharging occurring between the waypoints as an input variable; and determining a path to the destination based on the calculated costs.

According to another aspect of the present disclosure, a path finding apparatus includes: a destination setting unit setting a destination for a transport vehicle using a battery; a cost calculation unit calculating costs between waypoints to the destination using a cost function, which includes amounts of charging and discharging occurring between the waypoints as an input variable; and a path determination unit determining a path to the destination based on the calculated costs.

According to another aspect of the present disclosure, a transport system includes: a rail including powered sections where power lines for supplying power are installed and non-powered sections where the power lines are not installed; a plurality of transport vehicles moving along the rail and including batteries, which store power supplied through the power lines; and an overhead hoist transport (OHT) control system (OCS) controlling the transport vehicles, wherein the OCS sets a destination for each of the transport vehicles, calculates costs between waypoints to the destination using a cost function, which includes amounts of charging and discharging occurring between the waypoints as an input variable, and determines a path to the destination based on the calculated costs.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a conceptual diagram for explaining a transport system according to some embodiments of the present disclosure;

FIG. 2 is a conceptual plan view for explaining the transport system according to some embodiments of the present disclosure;

FIG. 3 is a drawing for explaining a transport vehicle of FIG. 1;

FIG. 4 is a block diagram for explaining a transport vehicle of the transport system according to some embodiments of the present disclosure;

FIG. 5 is a block diagram for explaining an overhead hoist transport (OHT) control server (OCS) of the transport system according to some embodiments of the present disclosure;

FIG. 6 is a conceptual diagram for explaining a path finding method according to some embodiments of the present disclosure;

FIG. 7 is a flowchart for explaining a path finding method according to some embodiments of the present disclosure;

FIG. 8 is a flowchart for explaining an exemplary method for accumulating training data for machine-learning a cost function;

FIG. 9 is a flowchart for explaining another exemplary method for accumulating training data for machine-learning a cost function, particularly, how to acquire training data through simulation, rather than from an on-site line; and

FIG. 10 is a flowchart for explaining an exemplary machine learning method using training data.

### DETAILED DESCRIPTION

Preferred embodiments of the present disclosure will hereinafter be described in detail with reference to the accompanying drawings. The advantages, features, and methods of achieving them will become clear with reference to the embodiments described in detail together with the accompanying drawings. However, the present disclosure is not limited to the embodiments disclosed below and can be implemented in various different forms. The embodiments are provided only to make the disclosure of the present disclosure complete and to fully inform those of ordinary skill in the art to which the present disclosure pertains, and the scope of the invention is defined by the claims. Throughout the specification, the same reference numerals refer to the same components.

Spatially relative terms such as “below,” “beneath,” “lower,” “above,” “upper,” etc., may be used to facilitate the description of the relationship of one or more elements or components to other elements or components as depicted in the drawings. Spatially relative terms should be understood to include different orientations of the elements or components in addition to the directions shown or described in the drawings. For instance, if the components depicted in the drawings are flipped, components described as “below” or “beneath” other components can be positioned “above” the other components. Therefore, the term “below” can include both directions, below and above. Elements or components can be oriented in different directions, and accordingly, spatially relative terms may be interpreted according to their orientation.

Although terms like first, second, etc., may be used to describe various elements, components, and/or sections, these elements, components, and/or sections should not be limited by these terms. These terms are only used to distinguish one element, component, or section from another. Thus, a first element, first component, or first section discussed below can be termed a second element, second component, or second section within the technical idea of the present disclosure.

Embodiments of the present disclosure will hereinafter be described in detail with reference to the attached drawings. In describing these embodiments with reference to the accompanying drawings, identical or corresponding components are given the same reference numerals, and redundant descriptions thereof will be omitted.

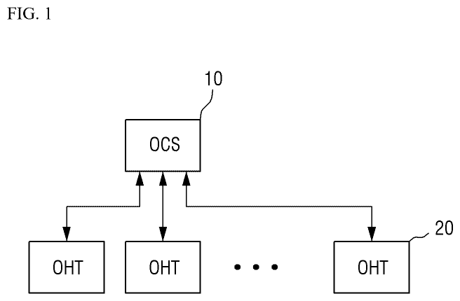

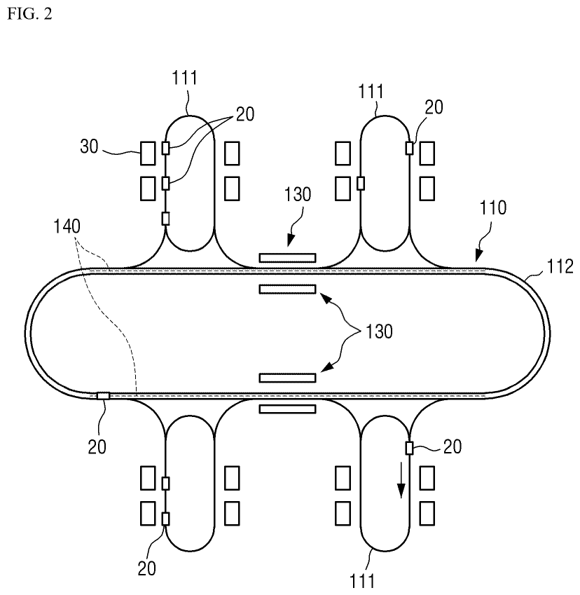

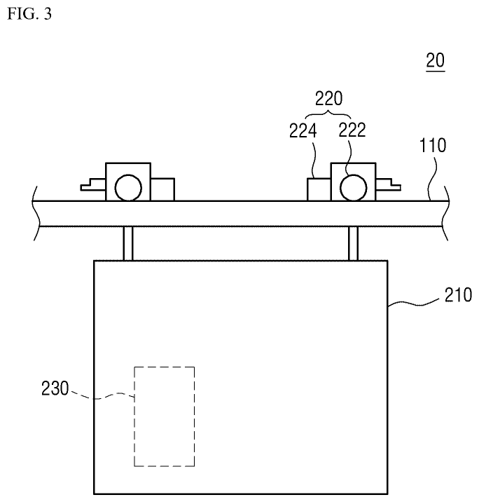

FIG. 1 is a conceptual diagram for explaining a transport system according to some embodiments of the present disclosure. FIG. 2 is a conceptual plan view for explaining the transport system according to some embodiments of the present disclosure. FIG. 3 is a drawing for explaining a transport vehicle of FIG. 1.

Referring to FIG. 1, the transport system according to some embodiments of the present disclosure includes an overhead hoist transport (OHT) control system (OCS) 10 and a plurality of transport vehicles 20.

The transport vehicles 20 may be OHTs that travel along rails installed on the ceiling of a semiconductor manufacturing plant (i.e., a FAB), but the present disclosure is not limited thereto.

The OCS 10 communicates with the transport vehicles 20 through, for example, a wireless communication method, and controls the transport vehicles 20.

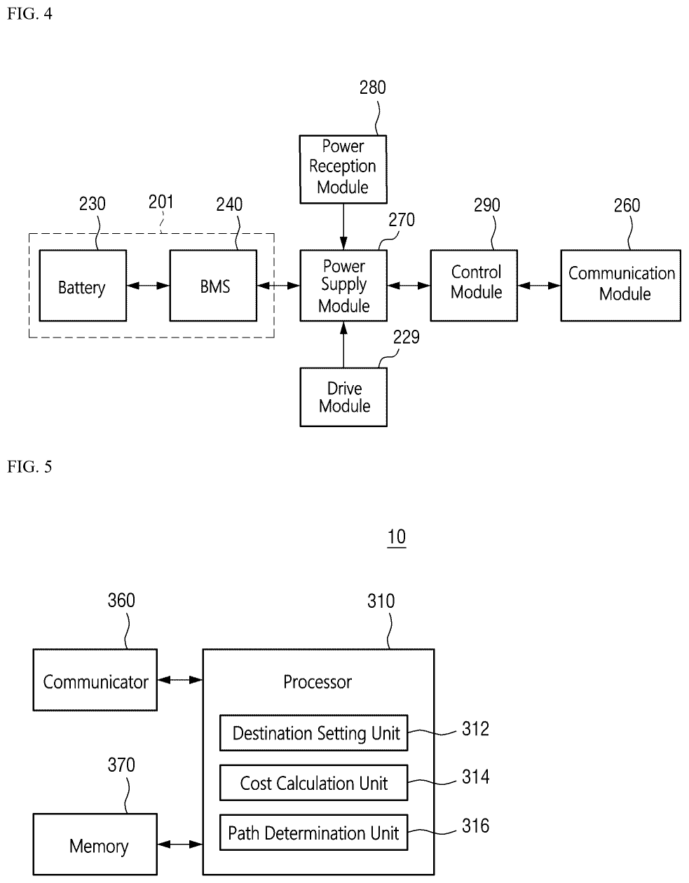

The OCS 10 determines the destination of the transport vehicles 20, calculates the costs between waypoints to the destination, and determines a path to the destination based on the calculated costs. A path finding method according to some embodiments of the present disclosure will be described later with reference to FIGS. 5 through 7. The OCS 10 provides a transport command to each of the transport vehicles 20 according to the determined path. The transport command may include information such as, for example, a starting location, an arrival location, and load to be transported.

Referring to FIG. 2, in the transport system according to some embodiments of the present disclosure, a rail 110 may be installed on the ceiling of the semiconductor manufacturing plant and may consist of straight sections and curved sections. The rail 110 may include a main passage 112 and a plurality of bay sections 111 branched from the main passage 112, but the present disclosure is not limited thereto.

The main passage 112 may have a closed-curve configuration, but the present disclosure is not limited thereto. Multiple bay sections 111 may be disposed on one side of the main passage 112, and other multiple bay sections 111 may be disposed on the other side of the main passage 112.

Furthermore, storage sections 130 for storing items (such as front opening unified pods (FOUPs), front opening shipping boxes (FOSBs), etc.) may be disposed in the main passage 112. A plurality of semiconductor manufacturing apparatuses 30 may be disposed in the bay sections 111.

The transport vehicles 20 may transport items from the storage section 130 to the semiconductor manufacturing apparatuses 30 or from the semiconductor manufacturing apparatuses 30 to the storage sections 130 while moving along the rail 110.

Meanwhile, the rail 110 includes powered sections where power lines 140 are installed and non-powered sections where the power lines 140 are not installed. The power lines 140 are illustrated in FIG. 1 as being installed in the straight sections of the main passage 112, but not in the curved sections of the main passage 112 nor in the bay sections 111, but the present disclosure is not limited thereto.

Referring to FIG. 3, a transport vehicle 20 includes a housing 210, a travel module 220, and a battery 230.

The travel module 220 is installed on the housing 210 and is movably installed along the rail 110. The travel module 220 includes travel wheels 222 and a motor 224 for rotating the travel wheels 222. In this specification, “travel wheels” refer to front travel wheels and/or rear travel wheels, and “motor” refers to at least one of a front motor that drives the front travel wheels and a rear motor that drives the rear travel wheels.

Inside the housing 210, a hoist module for gripping and lifting up or down items may be installed. For example, the hoist module may include a hoist unit for lifting up or down items, a slide unit for moving the hoist unit in a left-right direction, and a hand unit connected to the hoist unit for gripping items.

Additionally, the battery 230 is installed inside the housing 210. While moving along the rail 110, the transport vehicle 20 receives power from the power lines 140 of FIG. 2. The received power may be used to operate the travel module 220 or may be stored in the battery 230. When the transport vehicle 20 moves along sections of the rail 110 where the power lines 140 are not installed, the transport vehicle 20 operates the travel module 220 using the energy stored in the battery 230.

Meanwhile, referring again to FIG. 1, to determine the path to the destination of the transport vehicles 20, the OCS 10 calculates the costs between waypoints to the destination. In particular, input variables for a cost function used to calculate the costs not only include the distances and congestion levels between the waypoints, but also include the amounts of charging and discharging occurring between the waypoints.

FIG. 4 is a block diagram for explaining a transport vehicle of the transport system according to some embodiments of the present disclosure.

Referring to FIG. 4, a transport vehicle 20 includes an energy storage module 201, a drive module 229, a communication module 260, a power supply module 270, a power receiving module 280, and a control module 290.

The power receiving module 280 receives power from the power lines 140 installed in the rail 110. For example, the power receiving module 280 may receive power from the power lines 140 in a contactless manner. As an example of the contactless manner, high-efficiency inductive power distribution (HID) technology or contactless power supply (CPS) technology may be used, but the present disclosure is not limited thereto.

The power supply module 270 provides the power received from the power receiving module 280 to the drive module 229. The drive module 229 includes at least one module within the transport vehicle 20 that requires power. For example, the drive module 229 may be the travel module 220 of FIG. 3, a hoist module, or a sensor module, but the present disclosure is not limited thereto.

Additionally, the power supply module 270 may deliver power to the energy storage module 201. The power supply module 270 may selectively provide a constant current or a variable current to the energy storage module 201. Moreover, the power supply module 270 may selectively control the supply (or no supply) of power to the energy storage module 201.

When the transport vehicle 20 operates in non-powered sections of the rail 110 or when a predetermined level of output is required, the battery 230 may provide stored energy to the drive module 229 through the power supply module 270.

The battery 230 may be managed by a battery management system (BMS) 240. The BMS 240 may measure the remaining energy of the battery 230 to perform charging and discharging. Additionally, the BMS 240 may measure the energy efficiency or internal resistance of the battery 230 and may determine the lifespan of the battery 230 based on the results of the measurement.

The control module 290 may manage and control the power status and operation status of the transport vehicle 20. The control module 290 may generally control the transport vehicle 20, particularly, for example, the power receiving module 280, the power supply module 270, the drive module 229, the communication module 260, and the energy storage module 201.

The communication module 260 may be intended for communication with a plurality of entities. For example, the communication module 260 may include a communication module for communicating with the OCS 10 of FIG. 1, a communication module for reporting the internal status of the transport vehicle 20 to a diagnostic server, and a communication module for communicating with other transport vehicles 20.

FIG. 5 is a block diagram for explaining the OCS of the transport system according to some embodiments of the present disclosure. FIG. 6 is a conceptual diagram for explaining a path finding method according to some embodiments of the present disclosure.

Referring to FIG. 5, the OCS 10 includes a processor 310, a communicator 360, and a memory 370.

The processor 310 communicates with external entities through the communicator 360 and calculates cost using data stored in the memory 370.

The processor 310 sets a destination for a battery-powered transport vehicle 20 (or a transport vehicle 20 using its battery 230), calculates the costs between waypoints to the set destination, and determines a path to the set destination based on the calculated costs.

The memory 370 stores data necessary for the processor 310 to perform path finding. The stored data may include, for example, the distances between the waypoints and the amounts (particularly, average amounts) of charging and discharging between the waypoints. Moreover, the memory 370 may also store a cost function for determining the cost between the waypoints and weights for the cost function, and may further include instructions for the processor 310 to perform a path finding operation.

The memory 370 may include a volatile memory (such as a dynamic random-access memory (DRAM), a static random-access memory (SRAM), or a synchronous DRAM (SDRAM)) and/or a non-volatile memory (such as a one-time programmable read-only memory (OTPROM), a programmable read-only memory (PROM), an erasable PROM (EPROM), an electrically erasable PROM (EEPROM), a mask read-only memory (ROM), a flash ROM, a flash memory, a phase-change random-access memory (PRAM), a resistive random-access memory (RRAM), a magnetoresistive random-access memory (MRAM), a hard drive, or a solid-state drive (SSD)). The memory 370 may include an internal memory and/or an external memory, but the present disclosure is not limited thereto.

Meanwhile, functionally, the processor 310 may include a destination setting unit 312, a cost calculation unit 314, and a path determination unit 316.

The destination setting unit 312 sets the destination for the battery-powered transport vehicle 20. Specifically, for example, referring to FIG. 6, it is assumed that the start location for the operation of the battery-powered transport vehicle 20 is node A, and the destination (or arrival location) of the battery-powered transport vehicle 20 is node I.

The cost calculation unit 314 calculates the cost between waypoints to the destination.

Also, referring to FIG. 6, it is assumed that waypoints from node A to node I are nodes B, C, D, E, F, G, and H. The edges between nodes A, B, C, D, E, F, G, H, and I are displayed as lines.

Costs between pairs of adjacent waypoints are calculated. The adjacent waypoints may be nodes A and B (A-B), nodes A and C (A-C), nodes A and E (A-E), nodes B and D (B-D), nodes B and F (B-F), nodes B and G (B-G), nodes B and E (B-E), nodes C and E (C-E), nodes C and H (C-H), nodes D and F (D-F), nodes E and F (E-F), nodes E and G (E-G), nodes H and G (H-G), nodes F and I (F-I), and nodes G and I (G-I). Here, “A-B” means the edge between nodes A and B.

For example, the cost function for calculating the costs between the adjacent waypoints may include the amounts of charging and discharging that occur between the adjacent waypoints. Additionally, the cost function may further include the distances between the adjacent waypoints and the congestion levels between the adjacent waypoints.

The charging and discharging amounts may be included in the cost function for the following reason. The cost function is for finding a path for the battery-powered vehicle 20. Since the rail 110 includes powered sections and non-powered sections, not considering the charging and discharging amounts may lead to rapid depletion of the battery 230 of the battery-powered transport vehicle 20.

Specifically, a cost function cost (A, B) for calculating the cost between nodes A and B is as indicated by Equation 1 below. The cost function cost (A, B) calculates the cost incurred on the edge between nodes A and B.

cost(A, B)=α×(Distance)+β×(Congestion Level)+γ×(Charging/Discharging Amount) [Equation 1]

where α denotes a weight for the Distance variable, β denotes a weight for the Congestion Level variable, and γ denotes a weight for the Charging/Discharging Amount variable.

Referring to Equation 1, Distance refers to the distance between nodes A and B, Congestion Level refers to the number of transport vehicles 20 between nodes A and B, and Charging/Discharging Amount refers to the average sum of the amounts of charging and discharging occurring between nodes A and B.

As previously mentioned, the distance between nodes A and B and the average sum of the charging and discharging amounts between nodes A and B may be stored in memory 370. Therefore, the processor 310 may obtain the Distance and Congestion Level variables of Equation 1 from the memory 370.

The processor 310 receives the current locations of multiple transport vehicles 20 through the communicator 360. Thus, the processor 310 may determine the number of transport vehicles 20 present between nodes A and B. Accordingly, the processor 310 may calculate the Congestion Level variable of Equation 1.

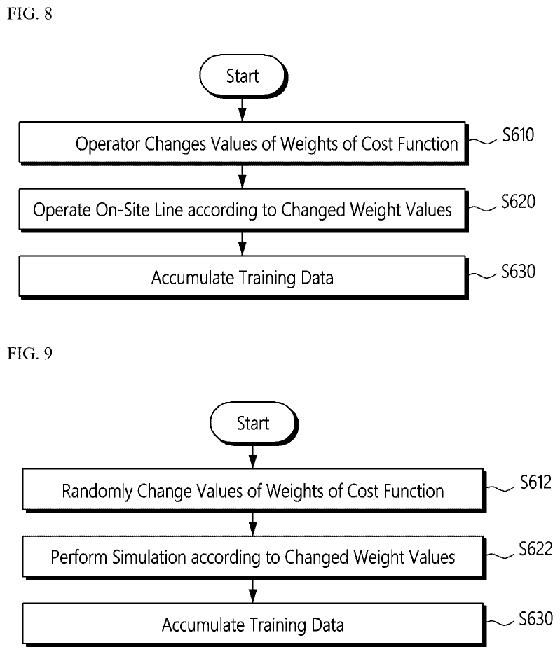

Furthermore, the weights α, β, and γ of the cost function cost (A, B) may be determined through a machine learning method that aims to maintain the State of Charge (SoC) of the battery 230 of each transport vehicle 20 at a target level. Alternatively, the weights α, β, and γ of the cost function cost (A, B) may be determined through a machine learning method that aims to minimize the transport time of each transport vehicle 20 while maximizing their battery 230′s SoC. A method for generating training data for such machine learning will be described later with reference to FIGS. 8 and 9.

Similarly to the method of using the cost function cost(A, B), costs may also be calculated for the other pairs of adjacent waypoints, i.e., nodes A and C (A-C), nodes A and E (A-E), nodes B and D (B-D), nodes B and F (B-F), nodes B and G (B-G), nodes B and E (B-E), nodes C and E (C-E), nodes C and H (C-H), nodes D and F (D-F), nodes E and F (E-F), nodes E and G (E-G), nodes H and G (H-G), nodes F and I (F-I), and nodes G and I (G-I).

The path determination unit 316 determines the path to the destination of the battery-powered transport vehicle 20 based on these calculated costs.

Specifically, the path to the destination may be determined using an algorithm such as, for example, Dijkstra's algorithm, the Floyd-Warshall algorithm, or the Bellman-Ford algorithm.

Dijkstra's algorithm is used when finding the shortest path from one node to another specific node, while the Floyd-Warshall algorithm is used when finding the shortest paths from all nodes to all other nodes.

Dijkstra's algorithm finds a shortest path by selecting an unvisited node with a shortest distance at each step. On the other hand, the Bellman-Ford algorithm calculates shortest distances between all nodes by checking all edges at each step. Unlike Dijkstra's algorithm, the Bellman-Ford algorithm may find a shortest path even if there are edges with negative costs.

The path determination unit 316 uses these algorithms to determine the path to the destination based on the calculated costs between the waypoints.

The OCS 10 provides a transport command corresponding to the determined path to the battery-powered transport vehicle 20 through the communicator 360.

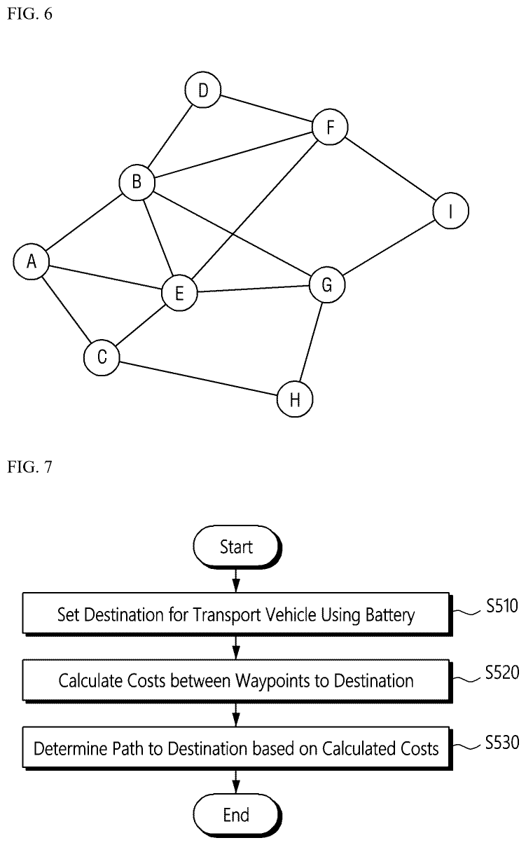

FIG. 7 is a flowchart for explaining a path finding method according to some embodiments of the present disclosure. For convenience of explanation, the embodiment of FIG. 7 will hereinafter be described, focusing mainly on aspects that differ from those explained with reference to FIGS. 1 through 6.

Referring to FIGS. 6 and 7, a destination for a battery-powered transport vehicle 20 is set (S510).

For example, the OCS 10 sets the start location of the battery-powered transport vehicle 20 as node A and the arrival location (or destination) of the battery-powered transport vehicle 20 as node I.

Thereafter, costs between waypoints to the destination are calculated (S520).

For example, if the waypoints from node A to node I are nodes B, C, D, E, F, G, and H, the OCS 10 calculates the costs between pairs of adjacent waypoints, i.e., nodes A and B (A-B), nodes A and C (A-C), nodes A and E (A-E), nodes B and D (B-D), nodes B and F (B-F), nodes B and G (B-G), nodes B and E (B-E), nodes C and E (C-E), nodes C and H (C-H), nodes D and F (D-F), nodes E and F (E-F), nodes E and G (E-G), nodes H and G (H-G), nodes F and I (F-I), and nodes G and I (G-I). A cost function for calculating these costs includes the amounts of charging and discharging that occur between the adjacent waypoints. Additionally, the cost function further includes the distances between the adjacent waypoints and the congestion levels between the adjacent waypoints.

Thereafter, the path to the destination is determined based on the calculated costs (S530).

The OCS 10 uses an algorithm such as Dijkstra's algorithm, the Floyd-Warshall algorithm, or the Bellman-Ford algorithm to determine the path to the destination.

A method for machine-learning a cost function will hereinafter be described with reference to FIGS. 8 through 10.

FIG. 8 is a flowchart for explaining an exemplary method for accumulating training data for machine-learning a cost function. It will hereinafter be described how to acquire training data from an actual on-site line with reference to FIG. 8.

Referring to FIG. 8, an operator changes the values of weights (S610).

Specifically, the operator arbitrarily determines the weights of a cost function based on an empirical rule. For example, the operator may determine the values of the weights α, β, and γ of the cost function cost(A, B) as α1, β1, and γ1 so that the cost function cost(A, B) may be determined as follows: cost(A, B)=α1×(Distance)+β1×(Congestion Level)+γ1×(Charging/Discharging Amount).

Thereafter, the on-site line is operated according to the determined weights (S620).

Specifically, the costs between the waypoints to the destination are calculated using the determined cost function. Based on the calculated costs, a path to the destination is determined using a predetermined algorithm (for example, Dijkstra's algorithm).

Here, operating the on-site line may mean operating each transport vehicle 20 on the on-site line for the production of semiconductor devices or deliberately for acquiring training data.

Thereafter, the results of operating the on-site line are accumulated as training data (S630).

The results of operating the on-site line based on the weight values α1, β1, and γ1 determined by the operator are accumulated as training data.

Thereafter, returning to step S610, the operator changes the values of the weights α, β, and γ to α2, β2, and γ2 and operates the on-site line and accumulates training data according to the weight values α2, β2, and γ2.

In this manner, the operator may accumulate training data by changing the weights of the cost function N times (where N is a natural number greater than or equal to 2). Training data may include, for example, weights, path data, serial numbers, starting SoC, arriving SoC, etc. The path data refers to the section each transport vehicle 20 is moving through (e.g., the section from node A to node B). The serial number represents the identifier (ID) of the transport vehicle 20. The starting SoC refers to the SoC at the starting location (e.g., at node A) of the transport vehicle 20. The arriving SoC refers to the SoC at the arrival location (e.g., at node B) of each transport vehicle 20. If the starting SoC is greater than the arriving SoC, it implies that more discharging than charging has occurred along the path from node A to node B. Conversely, if the arriving SoC is greater than the starting SoC, it implies that more charging than discharging has occurred along the path from node A to node B.

The training data may be as shown in Table 1 below, but the present disclosure is not limited thereto. For example, referring to Table 1 for data for a first iteration, the weights α, β, and γ are α1, β1, and γ1, respectively, and the starting SoC and arriving SoC of transport vehicle 001 moving from node A to node B are 90% and 70%, respectively. Referring to Table 1 for data for a N-th iteration, the weights α, β, and γ are α10, β10, and γ10, respectively, and the starting SoC and arriving SoC of transport vehicle 099 moving from node A to node I are 80% and 75%, respectively.

TABLE 1

| | | | | Path | Serial | Starting | Arriving |
|---|---|---|---|---|---|---|---|
| Iteration | α | β | γ | Data | No. | SoC | SoC |
| 1 | α1 | β1 | γ1 | A-B | 001 | 90% | 70% |
| 2 | α1 | β1 | γ1 | B-D | 001 | 70% | 60% |
| 3 | α2 | β2 | γ2 | B-G | 020 | 65% | 75% |
| . . . | . . . | . . . | . . . | . . . | . . . | . . . | . . . |
| N-2 | α9 | β9 | γ9 | D-F | 079 | 80% | 75% |
| N-1 | α10 | β10 | γ10 | B-I | 091 | 70% | 60% |
| N | α10 | β10 | γ10 | A-I | 099 | 80% | 75% |

FIG. 9 is a flowchart for explaining another exemplary method for accumulating training data for machine-learning a cost function, particularly, how to acquire training data through simulation, rather than from an on-site line. For convenience of explanation, the embodiment of FIG. 9 will hereinafter be described, focusing mainly on aspects that differ from those explained with reference to FIG. 8.

Referring to FIG. 9, the values of weights are changed randomly (S612).

As described earlier with reference to FIG. 8, in the case of acquiring training data from an on-site line, the values of weights are changed based mainly on the operator's experience, which, however, may not cover a wide range of values. In contrast, using simulation allows setting the weights to a wider range of values, even beyond the operator's prediction. A cost function is determined based on randomly determined weight values.

Thereafter, a simulation is conducted according to the changed weight values (S622).

Specifically, the cost function is determined based on the changed weight values, and costs between waypoints to a particular destination are calculated using the determined cost function. Based on the calculated costs, a path to the destination is determined using a particular algorithm. Then, a simulation is performed that moves each transport vehicle 20 according to the determined path.

Thereafter, the results of the simulation are accumulated as training data (S630).

Thereafter, returning to step S612, the values of the weights are changed randomly again, and a simulation is conducted according to the changed weight values, thereby accumulating training data. These processes are repeated N times. Training data accumulated in this manner may be in the format as shown in Table 1.

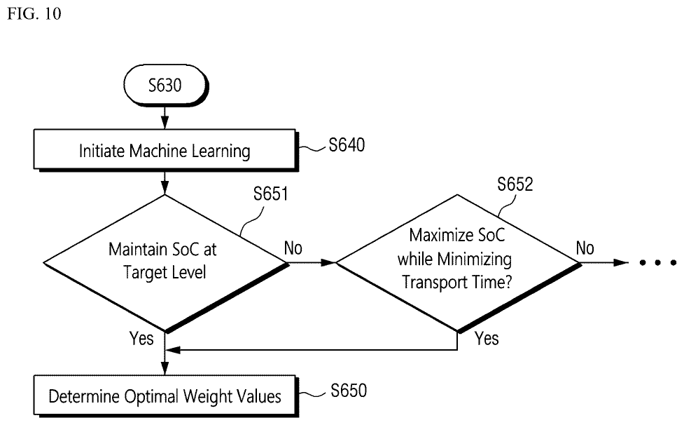

FIG. 10 is a flowchart for explaining an exemplary machine learning method using training data.

Referring to FIG. 10, machine learning begins (S640).

Specifically, machine learning commences using the training data accumulated through the method of FIG. 8 or 9. That is, machine learning starts to determine the values of the weights α, β, and γ of a cost function.

Supervised learning may be used as a machine learning algorithm, but the present disclosure is not limited thereto. Alternatively, unsupervised learning or semi-supervised learning may also be used.

The outcome of machine learning may vary depending on the objective of machine learning.

For example, the cost function may be optimized to maintain the SoC of the battery of each transport vehicle at a target level (“Yes” in step S651). The target level may be a value set in advance or a value input by the operator.

Alternatively, the cost function may be optimized to minimize transport time while maximizing the SoC of the battery of each transport vehicle (“Yes” in step S652).

The cost function may be optimized using, for example, an iterative method, but the present disclosure is not limited thereto.

In this manner, the optimal values of the weights are determined through machine learning (S650).

Although embodiments of the present disclosure have been described with reference to the accompanying drawings, it should be understood by those skilled in the art that the invention can be implemented in other specific forms without changing its technical spirit or essential features. Therefore, the described embodiments should be considered in all respects as illustrative and not restrictive.

What is claimed is:

1. A path finding method comprising:
setting a destination for a transport vehicle using a battery;
calculating costs between waypoints to the destination using a cost function, which includes amounts of charging and discharging occurring between the waypoints as an input variable; and
determining a path to the destination based on the calculated costs.

2. The path finding method of claim 1, wherein the cost function further includes distances and congestion levels between the waypoints as input variables.

3. The path finding method of claim 2, wherein the cost function for calculating a cost between first and second waypoints A and B is as follows:
$$cost ( A , B ) = α \times ( Distance ) + β \times ( Congestion Level ) + γ \times ( Charging / Discharging Amount )$$
where α, β, and γ are weights for the Distance, Congestion Level, and Charging/Discharging Amount variables, respectively.

4. The path finding method of claim 3, wherein values of the weights are determined through machine learning to maintain a State of Charge (SoC) of the battery of the transport vehicle at a target level.

5. The path finding method of claim 3, wherein values of the weights are determined through machine learning to maximize a SoC of the battery of the transport vehicle while minimizing transport time of the transport vehicle.

6. The path finding method of claim 1, wherein training data for learning the cost function includes weight values input by an operator when operating a line.

7. The path finding method of claim 1, wherein training data for learning the cost function includes weight values randomly changed through simulation.

8. The path finding method of claim 1, wherein
the transport vehicle moves along a rail, and
the rail includes powered sections where power lines for supplying power are installed and non-powered sections where the power lines are not installed.

9. A path finding apparatus comprising:
a destination setting unit setting a destination for a transport vehicle using a battery;
a cost calculation unit calculating costs between waypoints to the destination using a cost function, which includes amounts of charging and discharging occurring between the waypoints as an input variable; and
a path determination unit determining a path to the destination based on the calculated costs.

10. The path finding apparatus of claim 9, wherein the cost function further includes distances and congestion levels between the waypoints as input variables.

11. The path finding apparatus of claim 10, wherein the cost function for calculating a cost between first and second waypoints A and B is as follows:
cost(A, B)=α×(Distance)+β×(Congestion Level)+γ×(Charging/Discharging Amount)
where α, β, and γ are weights for the Distance, Congestion Level, and Charging/Discharging Amount variables, respectively.

12. The path finding apparatus of claim 11, wherein values of the weights are determined through machine learning to maintain a state of charge (SoC) of the battery of the transport vehicle at a target level.

13. The path finding apparatus of claim 11, wherein values of the weights are determined through machine learning to maximize a state of charge (SoC) of the battery of the transport vehicle while minimizing transport time of the transport vehicle.

14. The path finding apparatus of claim 9, wherein training data for learning the cost function includes weight values input by an operator when operating a line or weight values randomly changed through simulation.

15. A transport system comprising:
a rail including powered sections where power lines for supplying power are installed and non-powered sections where the power lines are not installed;
a plurality of transport vehicles moving along the rail and including batteries, which store power supplied through the power lines; and
an overhead hoist transport (OHT) control system (OCS) controlling the transport vehicles,
wherein the OCS sets a destination for each of the transport vehicles, calculates costs between waypoints to the destination using a cost function, which includes amounts of charging and discharging occurring between the waypoints as an input variable, and determines a path to the destination based on the calculated costs.

16. The transport system of claim 15, wherein the cost function further includes distances and congestion levels between the waypoints as input variables.

17. The transport system of claim 16, wherein a cost function for a path between first and second waypoints A and B is as follows:
$$cost ( A , B ) = α \times ( Distance ) + β \times ( Congestion Level ) + γ \times ( Charging / Discharging Amount )$$
where α, β, and γ are weights for Distance, Congestion Level, and Charging/Discharging Amount variables, respectively.

18. The transport system of claim 17, wherein values of the weights are determined through machine learning to maintain a state of charge (SoC) of the battery of each of the transport vehicles at a target level.

19. The transport system of claim 17, wherein values of the weights are determined through machine learning to maximize a state of charge (SoC) of the battery of each of the transport vehicles while minimizing transport time of the transport vehicles.

20. The path finding apparatus of claim 9, wherein training data for learning the cost function includes weight values input by an operator when operating a line or weight values randomly changed through simulation.
